(19) United States
(12) Patent Application Publication
(10) Pub. No.: US 2026/0074910 A1
(43) Pub. Date: Mar. 12, 2026

(54) TIME-ORDERED CRYPTOGRAPHIC LEDGERS

(71) Applicant: THE REGENTS OF THE UNIVERSITY OF COLORADO, A BODY CORPORATE, Denver, CO (US)

(72) Inventors: Jasper E.T. Palfree, Boulder, CO (US); Lynden K. Shalm, Boulder, CO (US)

(21) Appl. No.: 19/102,760

(22) PCT Filed: Aug. 10, 2023
(86) PCT No.: PCT/US2023/029948

§ 371 Date: Feb. 10, 2025

Related U.S. Application Data
(60) Provisional application No. 63/371,180, filed on Aug. 11, 2022.

(51) Int. Cl. H04L 9/32

(52) U.S. Cl. CPC H04L 9/3236

(57) ABSTRACT

A method includes receiving mix-in data from a remote computer node storing a remote ledger of a plurality of time-ordered cryptographic ledgers forming a tapestry. The mix-in data includes a remote identifier that uniquely identifies the remote ledger among the plurality of time-ordered cryptographic ledgers. The mix-in data also includes a remote hash value stored in a block of the remote ledger. The method includes generating a new hash value by hashing local event data, the mix-in data, a local identifier that uniquely identifies a local ledger among the plurality of time-ordered cryptographic ledgers, and a most-recent hash value of the local ledger. The method also includes constructing a new block that stores the local event data, the mix-in data, the local identifier, the most-recent hash value, and the new hash value. The method also includes updating the local ledger with the new block.

### RELATED APPLICATIONS

This application claims priority to U.S. Provisional Patent Application No. 63/371,180, filed on Aug. 11, 2022, the entirety of which is incorporated herein by reference.

### STATEMENT REGARDING FEDERALLY SPONSORED RESEARCH OR DEVELOPMENT

This invention was made with government support under grant number 70NANB18H006, awarded by the National Institute for Standards and Technology (NIST), and grant number 1839223, awarded by the National Science Foundation (NSF). The government has certain rights in the invention.

### BACKGROUND

A blockchain is a cryptographically linked one-dimensional chain of blocks. A blockchain may be audited to verify that data was correctly stored in the blocks.

### SUMMARY

The present embodiments include systems and methods that implement protocols for constructing and verifying a network of time-ordered events whose sources and temporal ordering can be cryptographically verified (e.g., by a third party). Also referred to herein as a “tapestry,” this network is structured to ensure both the integrity and verifiability of the history of events.

A tapestry uses partially decentralized cryptographic ledgers that are similar to blockchain ledgers except that they interact with one another to record events without the need for a completely decentralized blockchain (e.g., Ethereum). Accordingly, the present embodiments can accomplish many of the same tasks as a completely decentralized blockchain but with substantially less energy requirements. The cryptographic ledgers that make up a tapestry are lightweight, capable of running on nearly any device to provide either private or public secure record keeping at many different operational scales.

A tapestry provides a way to uniquely create secure information. This can be used, for example, to combat deep fakes in digital media and secure public contracts in a manner that is auditable. Any kind of information where temporal precedence needs to be established or verified can benefit from the present embodiments. Accordingly, applications include, but are not limited to, financial transactions (e.g., banking, securities trading, etc.), maintaining and verifying account histories, recording time-stamped readings (e.g., from smart meters), legal documents (e.g., dates and times of when documents are executed or notarized), inventory tracking, and proof-of-creation of documents. Another application of the present embodiments is verifying the randomness of randomly generated numbers.

### BRIEF DESCRIPTION OF THE FIGURES

FIG. 1 shows a tapestry formed from a plurality of time-ordered cryptographic ledgers, in embodiments.

FIG. 2 shows how the tapestry forms a transmission cone that establishes a verifiable temporal ordering of certain events recorded in the tapestry, in embodiments.

FIG. 3 is a functional diagram of a distributed system for constructing and managing the tapestry of FIG. 1, in embodiments.

FIG. 4 shows a block that is one example of a node, in an embodiment.

FIG. 5 shows a tapestry that is similar to the tapestry of FIG. 1 except that the ledgers are asymmetrically linked, in embodiments.

FIG. 6 shows a tapestry that is similar to the tapestries of FIGS. 1 and 5 except that nodes are added aperiodically to one of the ledgers, in embodiments.

FIG. 7 is a flowchart of a method for constructing a time-ordered cryptographic ledger that is part of a tapestry, in embodiments.

FIG. 8 illustrates reversed path traversal of the tapestry of FIG. 1, in embodiments.

FIG. 9 is a flowchart of a method that uses the reversed path traversal to verify time ordering of two events stored in a tapestry, in embodiments.

### DETAILED DESCRIPTION

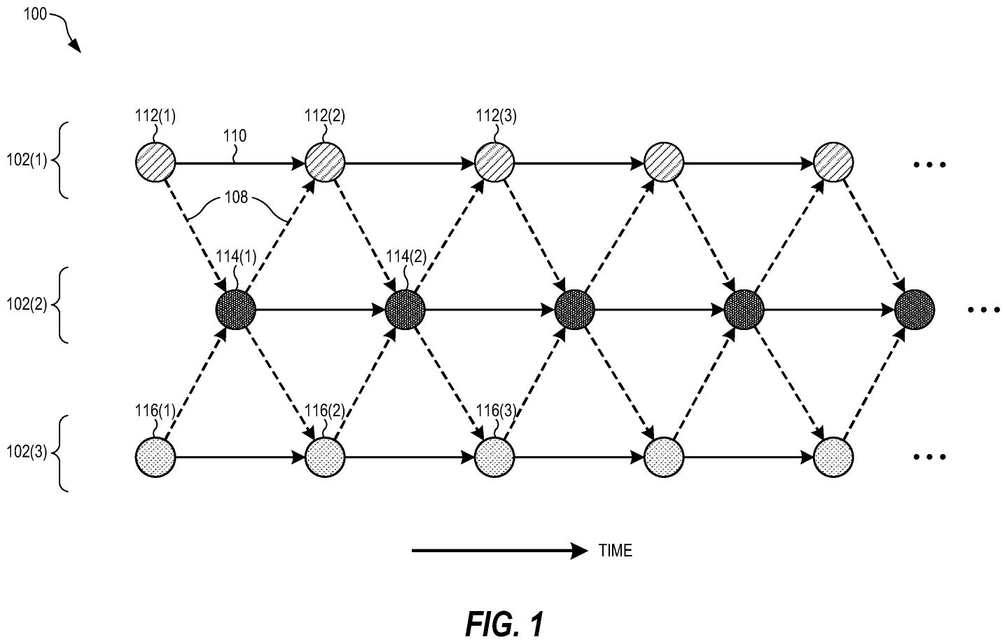

FIG. 1 shows a tapestry 100 formed from a plurality of time-ordered cryptographic ledgers 102, in accordance with the present embodiments. The tapestry 100 is represented as a directed acyclic graph with vertices represented as circles and edges represented as arrowed lines. For clarity herein, vertices may also be referred to as “nodes” or “blocks” while edges are also referred to as “links.” Also for clarity, each of the time-ordered cryptographic ledgers 102 is also referred to herein as simply a “ledger.”

Each ledger 102 is a cryptographically secured one-dimensional list, or “chain,” of nodes. Each ledger 102 is represented in FIG. 1 with nodes of different shadings. Specifically, a first ledger 102(1) has a first node 112(1) that links to a second node 112(2), which in turn links to a third node 112(3), and so on. Similarly, a second ledger 102(2) has a first node 114(1) that links to a second node 114(2), and so on. Finally, a third ledger 102(3) has a first node 116(1) that links to a second node 116(2), which in turn links to a third node 116(3), and so on. For clarity in FIG. 1, not all of the nodes and edges are labeled.

Each ledger 102 has a ledger identifier that uniquely identifies it among the plurality of ledgers in the tapestry 100. The ledger identifier may be generated, for example, by hashing ledger metadata. Examples of ledger metadata include a ledger name, IP address of a server storing the ledger 102, name of an organization maintaining the ledger, a creation date, and so on. The ledger metadata may contain additional or alternative information without departing from the scope hereof. Generating the ledger identifier by hashing helps ensure that the ledger identifiers are unique within the tapestry 100.

The links in FIG. 1 indicate how hash values are used to cryptographically link the nodes together. Specifically, a hash value between neighboring nodes within one ledger 102 is indicated in FIG. 1 with a solid line 110 (e.g., between the nodes 112(1) and 112(2) in the first ledger 102(1)). In addition, a hash value linking one ledger 102(i) to a different ledger 102(j≠i) is indicated with a dashed line 108 (e.g., between the node 112(1) in the first ledger 102(1) and the node 114(1) in the second ledger 102(2)). Hash values from a ledger 102 may be included in only one other ledger 102. For example, the first ledger 102(1) only links to the second ledger 102(2). Alternatively, hash values from one ledger 102 may be included in more than one other ledger 102. For example, hash values from the second ledger 102(2) are used by both the first ledger 102(1) and the third ledger 103(3). Hash values used to link between two ledgers 102 are also referred to herein as “mix-in values.”

Thus, each ledger 102 is FIG. 1 is similar to a blockchain (i.e., a cryptographically linked one-dimensional chain of blocks) in that each node is cryptographically linked to the one previous node of its own ledger 102. However, each ledger 102 differs from a conventional blockchain in that it is cryptographically linked to additional nodes in other ledgers 102. Due to these cross-ledger cryptographic links, the ledgers 102 are also referred to herein as being “entwined.” Similarly, the ledgers 102 are also referred to herein as “twice chains.” Furthermore, unlike conventional blockchain implementations, the ledgers 102 in FIG. 1 do not all store the same information. Rather, the ledgers 102 store different information, and therefore are not necessarily used for redundancy.

It is not necessary that hash values be directly transmitted from one ledger 102 to all of the other ledgers 102. For example, the first ledger 102(1) is not directly linked to the third ledger 102(2), and vice versa. Here, “directly” means that a hash value is transmitted from a source node to a destination node without passing through any other intervening node. For example, in FIG. 1, the node 112(2) directly transmits a hash value to the node 114(2). By comparison, an initial hash value is indirectly transmitted from the source node to the destination node if there is at least one intervening node that receives the initial hash value from the source node, generates a new hash value based on the initial hash value, and transmits the new hash value to the destination node. For example, in FIG. 1 the node 112(2) indirectly transmits a hash value to the node 116(3) via the intervening node 114(2). Thus, the ledgers 102(1) and 102(3) are only indirectly linked.

While the tapestry 100 of FIG. 1 has three ledgers 102, the tapestry 100 may alternatively have any number N_{c} of ledgers 102 greater than two. For example, the tapestry 100 may contain up to hundreds of thousands of ledgers 102, or more. In general, the ledgers 102 may be indexed by i=1 . . . N_{c}. Regardless of the value of N_{c}, hash values are directly transmitted from each ledger 102(i) to at least one other ledger 102(j≠i) in the tapestry 100 such that all hash values are transmitted, either directly or indirectly, to every ledger 102(1) . . . 102(N_{c}) in the tapestry 100. Thus, each ledger 102 is cryptographically linked, either directly or indirectly, to every other ledger 102 in the tapestry 100.

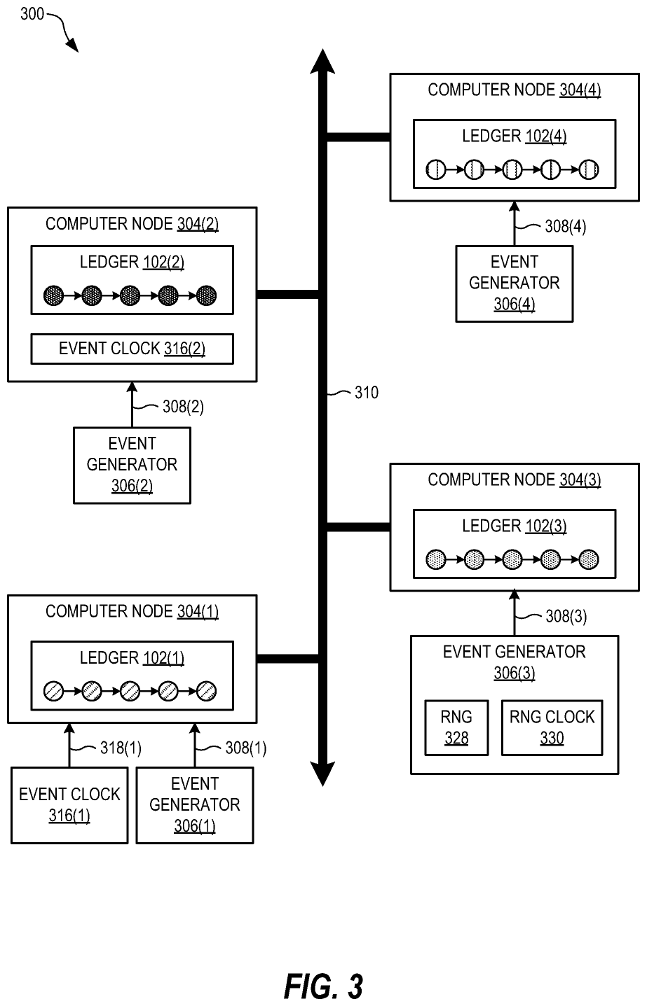

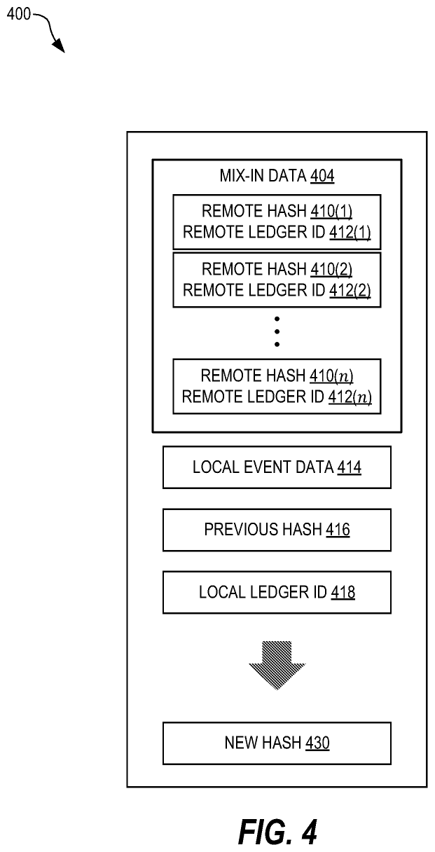

In some embodiments, each node represents an event that occurred at a particular time. In these embodiments, nodes may be added to a ledger 102 in the same order in which their representative events occurred in time. In this case, each ledger 102 is referred to as being “time-ordered.” For example, associated with the ledger 102(i) is an event generator that generates events (e.g., see event generators 306 in FIG. 3). Each new event triggers the generation of a new node in the corresponding ledger 102(i). The new node may be appended to the corresponding ledger 102(i) before the next event for the ledger 102(i) occurs, thereby ensuring the ledger 102(i) remains time-ordered. The new event includes new event data (e.g., see local event data 414 in FIG. 4) to be stored in the new node. Examples of new event data include, but are not limited to, a time stamp of the new event, an identifier, a file (e.g., a photo, video, audio, text, etc.), a random number, or any combination thereof.

To generate a new node for the ledger 102(i), a new hash value may be generated by hashing together (i) the most-recent hash value in the ledger 102(i) (i.e., the hash value of the most-recent node that was previously added to the ledger 102(i)), (ii) mix-in data received from other ledgers 102(j≠i), (iii) the new event data, and (iv) the ledger identifier of the ledger 102(i). Additional metadata for the ledger 102(i) may also be included in the hash. In one embodiment, the new event data is excluded from the hash. In some embodiments, the mix-in data includes not only the mix-in values, but the identifiers of the ledgers 102 from which the mix-in values were received. Since the new hash value is generated from a cryptographic hash function, it may be assumed to be unique among all of the nodes in the tapestry 100. Accordingly, the new hash value may also be thought of as a unique node identifier.

The new hash value may be stored with the most-recent hash value, mix-in data, new event data, and ledger identifier to form the new node, which is then appended to the ledger 102(i). Additional or alternative data may be stored in the new node without departing from the scope hereof (e.g., additional metadata of the ledger 102(i)). This new node then becomes the most-recent node of the ledger 102(i). Furthermore, the most-recent hash value of the ledger 102(i) is then updated to be the new hash value. In one embodiment, a cryptographic key may be used to digitally sign the data in the new node prior to storage therein. The cryptographic key may also then be stored in the new node. The public key used for verification may be stored as metadata in the ledger.

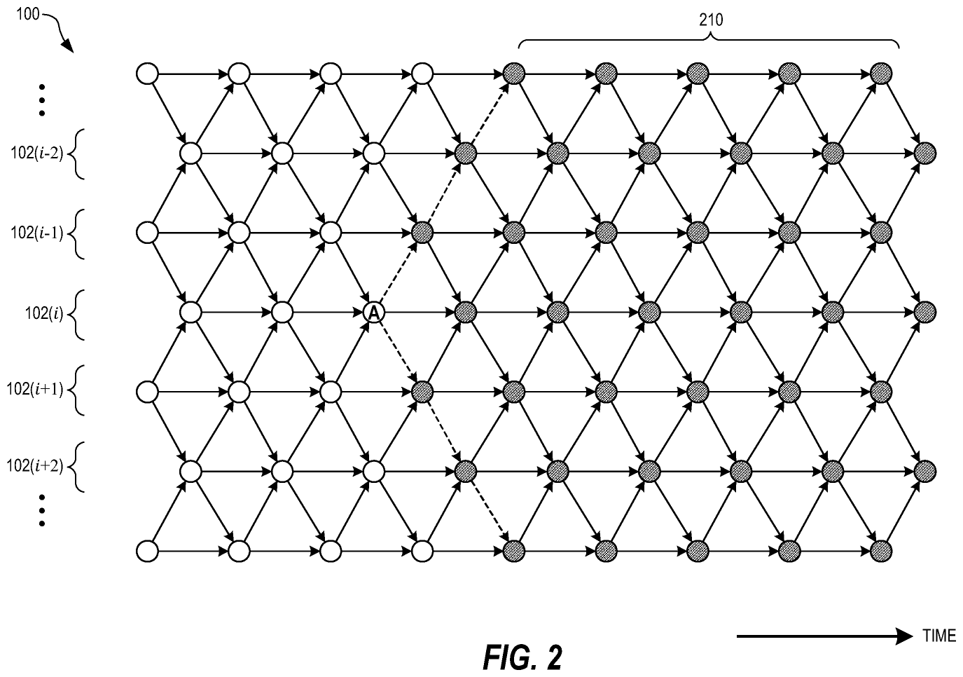

FIG. 2 shows how the tapestry 100 forms a transmission cone 210 that establishes a verifiable temporal ordering of certain events recorded in the tapestry 100. For clarity, only five of the ledgers 102 are labeled in FIG. 2. In FIG. 2, consider an event A that is recorded in an origin node of the 102(i). This origin node, shown in FIG. 2 with the label “A”, is the temporally earliest node in which information about the event A appears in the tapestry 100. The hash value from the origin node is then transmitted to neighboring ledgers 102(i−1) and 102(i+1), where it is cryptographically joined, or “entwined,” with additional information received from other nodes in other ledgers 102. From there, newer hash values are then generated and transmitted to additional neighboring ledgers 102(i−2) and 102(i+2). This process continues until the event A is “entwined” with all of the ledgers 102 in the tapestry 100.

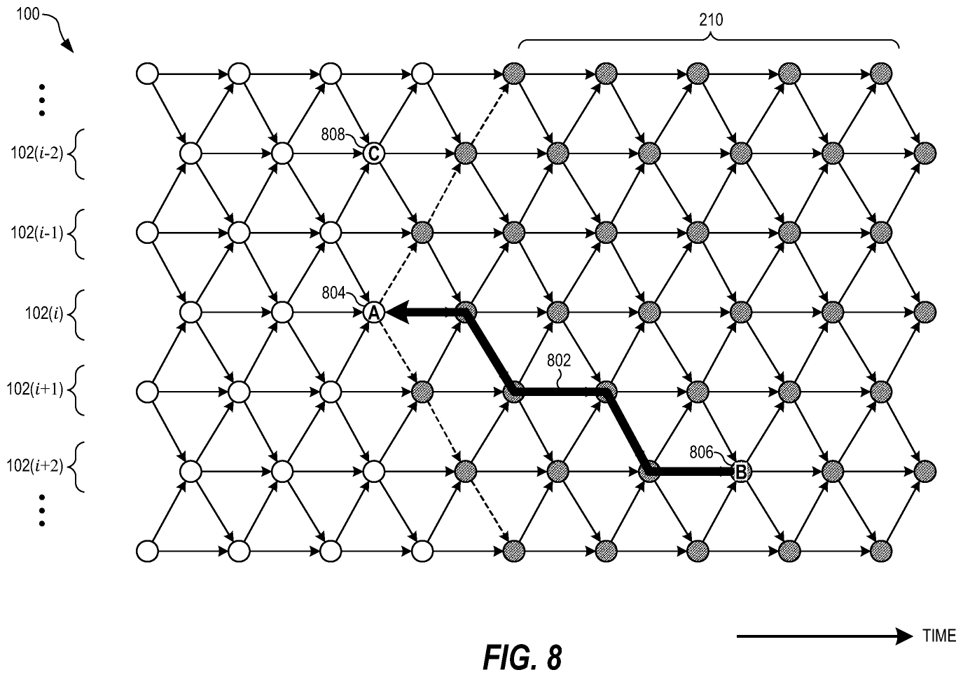

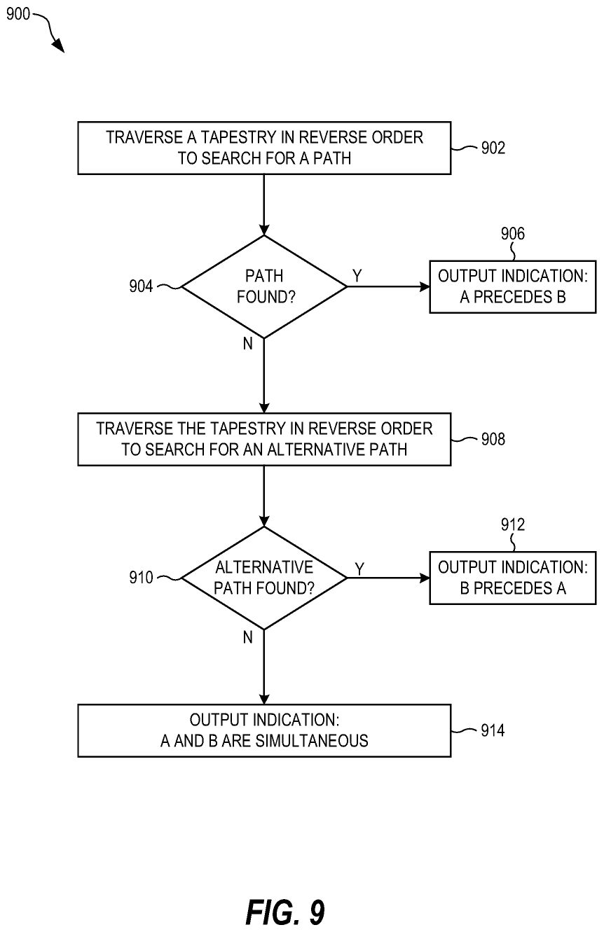

In FIG. 2, all of the nodes that are cryptographically linked to the event A are shown as shaded. These nodes, along with the origin node, form the transmission cone 210. Similar to how light cones are used in special relativity to define the concept of causality, the transmission cone 210 may be used to define causality of the events represented by the ledger nodes. To further clarify this causality, the direction of time is represented by a time arrow in both FIGS. 1 and 2. More information about how to verify time ordering is described below with regards to FIGS. 8 and 9.

FIG. 3 is a functional diagram of a distributed system 300 for constructing and managing the tapestry 100 of FIG. 1, in accordance with some of the present embodiments. The system 300 includes a plurality of computer nodes 304 that communicate with each other over a network 310 (e.g., the Internet, LAN, WAN, wireless mesh network, etc.). Each computer node 304(i) stores a corresponding ledger 102(i) that is unique to the computer node 304(i). For example, a first computer node 304(1) stores the first ledger 102(1), a second computer node 304(2) stores the second ledger 102(2), and so on. Each computer node 304(i) may include a processor, a memory in communication with the processor, and machine-readable instructions stored in the memory. The machine-readable instructions, when executed by the processor, control the computer node 304(i) to implement any of the functionality described herein.

While FIG. 3 shows the system 300 with four computer nodes labeled 304(1) through 304(4), the system 300 may have up to thousands of computer nodes 304, or more. The system 300 is “distributed” in that the computer nodes 304 may be separated over a large geographic area. For example, each computer node 304(i) may be maintained by a separate company, laboratory, institution, or other type of entity. Alternatively, the system 300 may be local or a combination of local and distributed.

In some embodiments, the distributed system 300 includes one or more event generators 306 that generate event data 308 used by the computer nodes 304. In the example of FIG. 3, each computer node 304(i) has a respective event generator 306(i) that locally transmits event data 308(i) to the computer node 304(i). For example, a first event generator 306(1) generates first event data 308(1) that is transmitted to the first computer node 304(1), a second event generator 306(2) generates second event data 308(2) that is transmitted to the second computer node 304(2), and so on. In other embodiments, one or more of the event generators 306 are remote from their respective computer nodes 304. In this case, a remote event generator 306(i) may transmit the event data 308(i) to the computer node 304(i) via the network 310 or a different network. While FIG. 3 shows all of the computer nodes 304 with event generators 306, it is not necessary that every computer node 304 have an event generator 306.

In some embodiments, at least one event generator 306 includes a random number generator. For example, FIG. 3 shows the third event generator 306(3) with a random number generator (RNG) 328 configured to generate one or more random numbers. The third event generator 306(3) also includes an RNG clock 330 that is used to generate a time stamp each time the RNG 328 generates a random number. The third event generator 306(3) transmits the random number and its corresponding time stamp to the third computer node 304(3) as the event data 308(3). In another embodiment, the third event generator 306(3) generates random numbers without time-stamping, in which case the RNG clock 330 may be excluded.

In some embodiments, the system 300 includes one or more event clocks 316 that generate time stamps 318. For example, FIG. 3 shows a first event clock 316(1) that generates time stamps 318(1) simultaneously with events generated by the first event generator 306(1). The first event clock 316(1) transmits the time stamps 318(1) to the first computer node 304(1) with the event data 308(1). As described above for the third event generator 306(3), an event clock may be part of an event generator 306, in which case the time stamps may be considered as part of the event data 308. Alternatively, an event clock 316 may be part of the computer node 304. For example, FIG. 2 shows the second event clock 316(2) as part of the second computer node 316(2). In this case, the event data 308(2) excludes time stamps.

FIG. 4 shows a block 400 that is one example of a node. The block 400 may be used, for example, for any of the nodes 112, 114, and 116 shown in FIG. 1. The block 400 stores data that is used to make a new hash value 430: (i) mix-in data 404, (ii) local event data 414, (iii) a previous hash value 416, and (iv) a local ledger identifier (ID) 418. The mix-in data 404 may be implemented as a table or array of n remote hash values 410(1) . . . 410(n) received from n other ledgers 102 (e.g., as stored on n remote computer nodes 304). In some embodiments, the mix-in data 404 also contains n remote ledger IDs 412(1) . . . 410(n) uniquely corresponding to the n remote hash values 410(1) . . . 410(n). Thus, the remote ledger ID 412(1) identifies the remote ledger storing the remote hash value 410(1), the remote ledger ID 412(2) identifies the remote ledger storing the remote hash value 410(2), and so on. In embodiments, the mix-in data 404 includes, at most, only one remote hash value 410 from any one ledger 102. In some embodiments, n is any integer greater than or equal to 1.

A local computer node (e.g., any one of the computer nodes 304 in FIG. 3) may generate the new hash value 430 by hashing the mix-in data 404, local event data 414, previous hash value 416, and local ledger ID 412. For example, the local computer node may append or merge these three pieces of data into a single numeric or alphanumeric string, which it then feeds into a hash algorithm that returns the new hash value 430. The block 400 may store additional or alternative data than shown in FIG. 4 without departing from the scope hereof. Accordingly, this additional or alternative data may be included in the hashing.

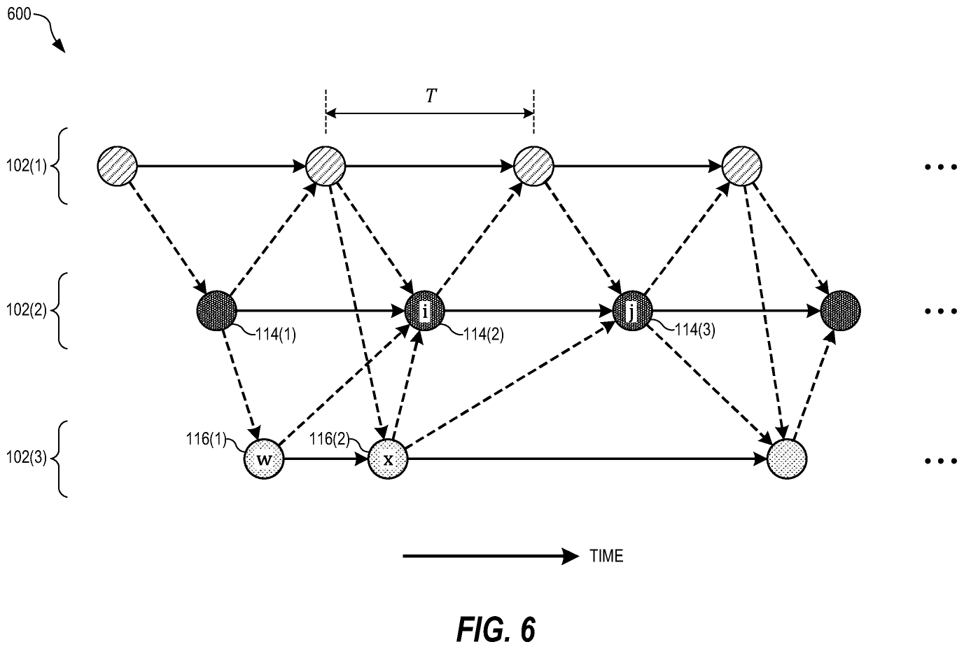

In some embodiments, a local computer node stores a table of most-recent mix-in data to keep track of the mix-in data 404. When the local computer node receives new mix-in data, it searches the table for the remote ledger identifier from which the new mix-in data originated. When an entry is found, it then replaces the mix-in value (i.e., the remote hash value) in the table with the newly-received mix-in value. When the local computer node constructs the block 400, it may then simply copy all of the data in this table to the block 400. In this manner, it is possible for two or more consecutive nodes in one ledger to all have the same mix-in value from one remote ledger (see FIG. 6 for an example of this behavior).

After the block 400 has been appended to the local ledger 102, the local computer node may then send the new hash value 430 to one or more remote ledgers 102. In one embodiment, the new hash value 430 is not transmitted to any remote ledger 102.

In other embodiments, the block 400 is generated by a computing device (e.g., a smartphone) that is remote from the local computer node (e.g., a server). That is, generation of the block 400 and storage of the ledger 102 may be performed by different systems or devices. In this case, the mix-in values are transmitted to the computing device, which creates the block 400 and then transmits it to the local computer node. The local computer node may verify the block 400. Once verified, the block may then be appended to the local ledger 102. In this case, it is not necessary for the local computer node to receive mix-in values.

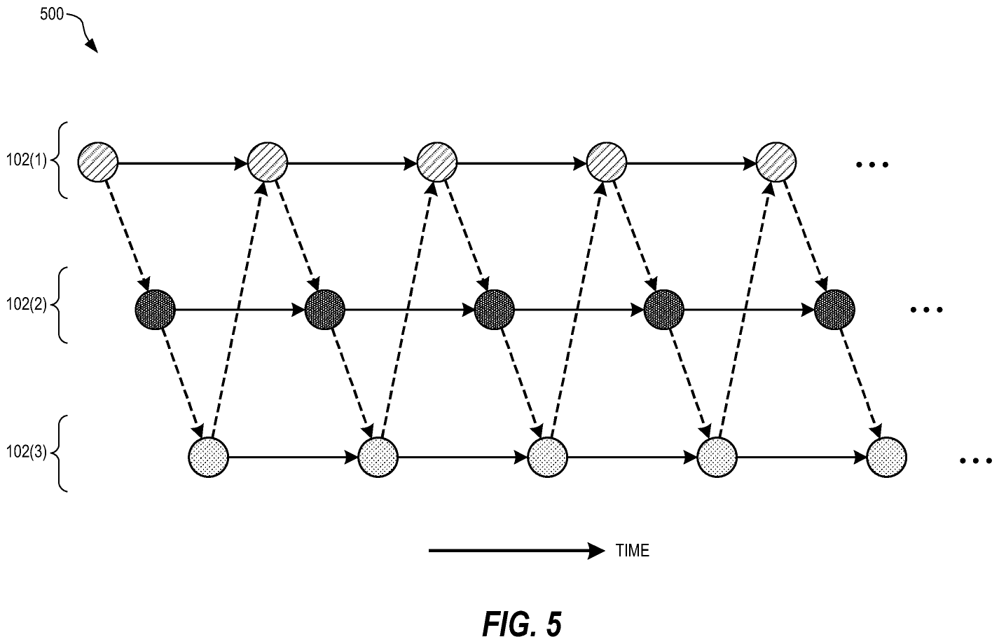

FIG. 5 shows a tapestry 500 that is similar to the tapestry 100 of FIG. 1 except that the ledgers 102 are asymmetrically linked rather than symmetrically linked. In FIG. 1, the first ledger 102(1) and second ledger 102(2) are symmetrically linked in that (i) each node 112 of the first ledger 102(1) receives a remote mix-in value from the second ledger 102(2) and transmits a new mix-in value back to the second ledger 102(2), and (ii) each node 114 of the second ledger 102(2) receives a mix-in value from the first ledger 102(1) and transmits a new mix-in value back to the first ledger 102(1). The result is that mix-in values are transmitted back-and-forth between the ledgers 102(1) and 102(2) in an alternating fashion (thereby forming a zig-zag line with time, as also shown in FIG. 1).

In FIG. 5, the ledgers 102 are asymmetrically linked in that each node does not transmit a new mix-in value back to the ledger 102 from which it directly received a mix-in value. Instead, the new mix-in value is directly transmitted to the ledger 102 from which the node did not receive a direct mix-in value. In embodiments, the tapestry 100 of FIG. 1 may include a first subset of ledgers 102 that are asymmetrically linked and a second subsect of ledgers 102 that are symmetrically linked (i.e., the topology can mix ledgers 102 that are symmetrically linked and asymmetrically linked).

FIG. 6 shows a tapestry 600 that is similar to the tapestries 100 and 500 except that nodes are added to the third ledger 102(3) aperiodically. Specifically, the events recorded in the third ledger 102(3) do not occur regularly in time. By contrast, nodes are added to each the first ledger 102(1) and second ledger 102(2) periodically. Specifically, events recorded in the first ledger 102(1) occur regularly with a period T, corresponding to an event-generation rate of f=1/T. Events recorded in the second ledger 102(2) also occur regularly with the same period T and therefore the same event-generation rate f. In FIG. 2, the nodes of the second ledger 102(2) are temporally offset from the nodes of the first ledger 102(1), indicating that the events for the first ledger 102(1) and the events for the second ledger 102(2) do not occur at the same moment in time (even though they are generated at the same frequency). Alternatively, the first ledger 102(2) and second ledger 102(2) may generate events without this temporal offset. In another embodiment, events recorded in the second ledger 102(2) occur regularly at a period different from T, and therefore at an event-generation rate different from f.

The example of FIG. 6 shows that periodicity of events is not necessary. A ledger 102 whose events are generated periodically is referred to herein as being “periodic” while a ledger 102 whose events are generated aperiodically is referred to herein as being “aperiodic.” In FIG. 3, the first ledger 102(1) and second ledger 102(2) are each examples of periodic ledgers while the third ledger 102(3) is an example of an aperiodic ledger. In some of the present embodiments, the tapestry 100 includes at least one ledger 102 that is periodic and at least one ledger 102 that is aperiodic. In one embodiment, all of the ledgers 102 of the tapestry 100 are periodic. In another embodiment, all of the ledgers 102 of the tapestry 100 are aperiodic.

In other embodiments, a ledger 102 can switch between being periodic and aperiodic. Specifically, during one or more certain time intervals the ledger 102 is periodic while during one or more other time intervals the ledger 102 is aperiodic. A ledger 102 whose events are only generated periodically is referred to herein as being “strictly periodic” while a ledger 102 whose events are only generated aperiodically is referred to herein as being “strictly aperiodic.” A ledger 102 that can accommodate both periodic and aperiodic event generation is referred to herein as being “non-strict.” In some embodiments, the tapestry 100 includes at least one ledger 102 that is non-strict. In other embodiments, the tapestry 100 includes only ledgers 102 that are strictly periodic, strictly periodic, or a combination thereof (i.e., the tapestry 100 excludes any ledgers 102 that are non-strict).

FIG. 6 also shows how the same single mix-in value from one ledger 102 can be used to cryptographically link to several nodes (i.e., two or more) of a different ledger 102. Specifically, the second node 116(2) of the third ledger 102(3) (labeled with event “x”) is linked to both the second node 114(2) and the third node 114(3) of the second ledger 102(2) (labeled with events “i” and “j”, respectively). Accordingly, the nodes 114(2) and 114(3) both use the same mix-in value from the node 116(2). This topology arises when the second ledger 102(2) generates new nodes faster than the third ledger 102(3). As shown in FIG. 6, these several nodes may occur sequentially in time.

FIG. 6 also shows how several (i.e., two or more) mix-in values from one ledger 102 can be used to cryptographically link to the same one node of a different ledger 102. Specifically, the first node 116(1) of the third ledger 102(3) (labeled with event “w”) and the second node 116(2) of the third ledger 102(3) are both linked to the second node 114(2) of the second ledger 102(2). Accordingly, the second node 114(2) uses the mix-in values from both the first node 116(1) and the second node 116(2). This topology arises because the third ledger 102(3) generates new nodes faster than the second ledger 102(2). As shown in FIG. 6, these several nodes may occur sequentially in time.

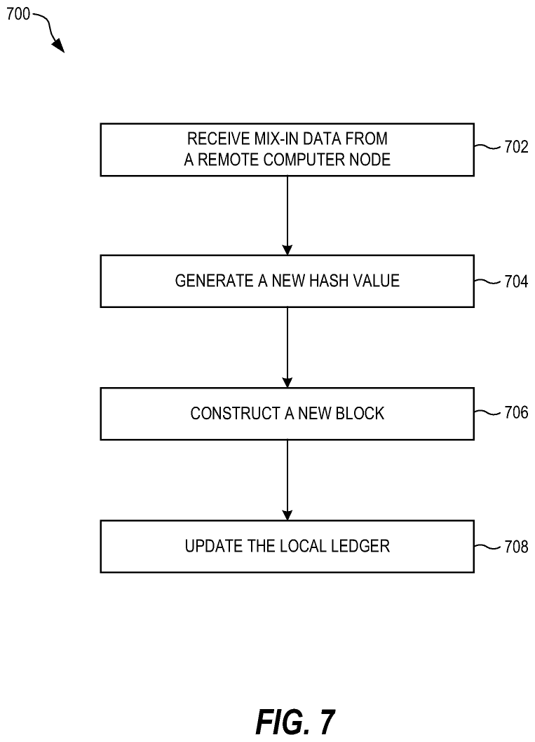

FIG. 7 is a flowchart of a method 700 for constructing a time-ordered cryptographic ledger that is part of a tapestry. The method 700 may be performed, for example, by any one of the computer nodes 304 shown in FIG. 3. With regards to the method 700, this one computer node 304 is referred to as the “local computer node” while all other computer nodes 304 are referred to as “remote computer nodes.”

In step 702 of the method 700, mix-in data is received from a remote computer node of one or more remote computer nodes storing one or more remote ledgers, respectively, of a plurality of time-ordered cryptographic ledgers forming a tapestry. The mix-in data includes a remote identifier that uniquely identifies a remote ledger, of the one or more remote ledgers, among the plurality of time-ordered cryptographic ledgers. The remote ledger is stored on the remote computer node. The mix-in data also includes a remote hash value stored in a block of the remote ledger.

In one example of the step 702, the first computer node 304(1) of FIG. 3 is the local computer node, the first ledger 102(1) is the local ledger, the second computer node 304(2) is the remote computer node, and the second ledger 102(2) is the remote ledger. In this example, the second computer node 304(2) transmits, to the first computer node 304(2), mix-in data that includes a hash value stored in the second ledger 102(2) and an identifier that identifies the second ledger 102(2).

In step 704 of the method 700, a new hash value is generated by hashing (i) local event data, (ii) the mix-in data, (iii) a local identifier that uniquely identifies a local ledger among the plurality of time-ordered cryptographic ledgers, and (iv) a most-recent hash value of a most-recent block of the local ledger. In step 706 of the method 700, a new block is constructed. This new block stores (i) the local event data, (ii) the mix-in data, (iii) the local identifier, (iv) the most-recent hash value, and (v) the new hash value. In step 708 of the method 700, the local ledger is updated with the new block.

In one example of the steps 704, 706, and 708, the first computer 304(1) receives event data 308(1) from the first event generator 306(1). The first computer 304(1) hashes the event data 308(1), the mix-in data received from the second computer node 304(2), an identifier that identifies the first ledger 102(2), and the most-recent hash value stored in the first ledger 102(1) to generate the new hash value. The first computer 304(1) then constructs a new block storing the new hash value (e.g., see the block 400 of FIG. 4). The first computer 304(1) then adds this new block to the first ledger 102(1).

In some embodiments, the method 700 is performed on a computer system (e.g., a server) that stores the local ledger. In these embodiments, the computer system may update the local ledger (i.e., the step 708) by appending the new block to it. In other embodiments, the method is performed by an auxiliary computing device that does not store the local ledger. Rather, the local ledger is stored on a local computer system that communicates with the auxiliary computing device. In this case, the auxiliary computing device may receive the mix-in data from the remote computer node either directly or indirectly through the local computer system. The auxiliary computing devices the local identifier and the most-recent has value from the local computer system. After constructing the new block, the auxiliary computing device then transmits the new block to the local computing system, which then appends the new block to the local ledger. Examples of the auxiliary computing device include, but are not limited to, a laptop computer, a smartphone, a tablet, a digital camera, and a digital watch.

FIG. 8 illustrates reversed path traversal of the tapestry 100. FIG. 9 is a flowchart of a method 900 that uses reversed path traversal to verify time ordering of two events stored in a tapestry formed from a plurality of time-ordered cryptographic ledgers. The method 900 may be used to answer the question: given a first event A and a second event B, did the first event A precede the second event B, the second event B precede the first event A, or neither? FIGS. 8 and 9 are best viewed together with the following description.

In step 902 of the method 900, the tapestry is traversed in reverse order (i.e., reversed path traversal is performed on the tapestry) to search for a path that starts with the first event A and ends with the second event B. The first event A is stored in a first block of a first ledger of the plurality of time-ordered cryptographic ledgers while the second event B is stored in a second block of a second ledger of the plurality of time-ordered cryptographic ledgers. The method 900 then continues to a decision block 904 that checks to see if the path was found. If yes, the method 900 continues to the step 906, where an indication that the first event A preceded the second event B is outputted. The indication may, for example, be displayed on a computer screen or monitor, or used for another application.

As an example of the step 902, consider the first event “A” stored in a node 804 of the ledger 102(i), as shown in FIG. 8. Similarly, consider the second event “B” stored in a node 806 of the ledger 102(i+2). The tapestry 100 is traversed backwards, or in reverse order (i.e., in the opposite direction of the arrow), to see if a path can be found that starts at the node 804 and ends at the node 806. This reversed path traversal starts at the node 806 and considers all paths that go backwards in time until either (a) the node 804 is found or (b) there are no more nodes to search. In the is later case, no path was found. Reversed path traversal can be implemented, for example, using recursive techniques known in the art.

The existence of a path 802 in FIG. 8 indicates that the node 806 was added to the ledger 102(i+2) after the node 804 was added to the ledger 102(i). Therefore, the second event B occurred after the first event A by enough that the node 806 lies within the transmission cone 210 of the first event A, thereby unambiguously establishing the temporal order of the events A and B. Note that the path 802 shown in FIG. 8 is not the only path connecting the nodes 804 and 806. Furthermore, the time t_{B} at which the second event B occurred provides an upper time bound for the time t_{A} at which the first event A occurred. Similarly, the time t_{A} provides a lower time bound for t_{B}. The time t_{A} may be stored in the node 804 (e.g., as part of the local event data 414 in FIG. 4). Similarly, the time t_{B} may be stored in the node 806. As part of the step 906, one or both of the times t_{A} and t_{B} may also be outputted.

Referring back to FIG. 9, if no path was found, the method 900 continues to step 908, where the tapestry is traversed in reverse order to search for an alternative path that starts with the second event B and ends with the first event A. The method 900 then continues to a decision block 910 that checks to see if the alternative path was found. If yes, the method 900 continues to the step 912, where an indication that the second event B preceded the first event B is outputted. One or both of the times t_{A} and t_{B} may also be outputted.

As an example of the step 908, consider the scenario shown in FIG. 8, except with the events A and B swapped. In this case, the reversed path traversal performed for the step 902 would begin at the node 804, and therefore would never find the node 806. The method 900 would then proceed to the decision block 910, which would perform reversed path traversal starting at the node 806. This second reversed path traversal would then find the path 802.

Referring back to FIG. 9, if no alternative path was found, the method 900 continues to step 914, wherein an indication of simultaneity is outputted. As an example of the step 914, consider in FIG. 8 an event C stored in a node 808 of the ledger 102(i−2). Compared to the event A, the node 808 does not lie in the transmission cone 210 of the node 804. Similarly, the node 804 does not lie in the transmission cone of the node 808. Accordingly, there is no path between the nodes 804 and 808. In this case, the events A and B are described as occurring “simultaneously,” where the term “simultaneously” is used herein to mean that event B does not lie with the transmission cone of event A and vice versa. As part of the step 914, one or both of the times t_{A} and t_{B} may also be outputted.

The method 900 may be performed independently of the method 700 of FIG. 7. For example, the method 900 may be performed by a computer system that does not participate in creating new blocks and growing the tapestry 100. Similarly, the method 700 may be performed by a computer system that does not verify time ordering. In other embodiments, a single computer system performs both of the methods 700 and 900.

### Combinations of Features

Features described above as well as those claimed below may be combined in various ways without departing from the scope hereof. The following examples illustrate possible, non-limiting combinations of features and embodiments described above. It should be clear that other changes and modifications may be made to the present embodiments without departing from the spirit and scope of this invention:

(A1) A method performed by a local computer node includes receiving mix-in data from a remote computer node of one or more remote computer nodes storing one or more remote ledgers, respectively, of a plurality of time-ordered cryptographic ledgers forming a tapestry. The mix-in data includes a remote identifier that uniquely identifies a remote ledger, of the one or more remote ledgers, among the plurality of time-ordered cryptographic ledgers. The remote ledger is stored on the remote computer node. The mix-in data also includes a remote hash value stored in a block of the remote ledger. The method includes generating a new hash value by hashing (i) local event data, (ii) the mix-in data, (iii) a local identifier that uniquely identifies a local ledger among the plurality of time-ordered cryptographic ledgers, and (iv) a most-recent hash value of a most-recent block of the local ledger. The method also includes constructing a new block that stores (i) the local event data, (ii) the mix-in data, (iii) the local identifier, (iv) the most-recent hash value, and (v) the new hash value. The method also includes updating the local ledger with the new block.

(A2) In the method denoted (A1), the method further includes transmitting, to at least one of the one or more remote computer nodes, (i) the new hash value and (ii) the local identifier.

(A3) In either of the methods denoted (A1) and (A2), the method further includes receiving the local event data.

(A4) In any of the methods denoted (A1) to (A3), the method further includes generating a time stamp. The local event data includes the time stamp.

(A5) In any of the methods denoted (A1) to (A4), the method further includes generating one or more random numbers. The local event data includes the one or more random numbers.

(A6) In any of the methods denoted (A1) to (A5), said updating includes transmitting the new block to a local computer system storing the local ledger.

(A7) In any of the methods denoted (A1) to (A6), the method further includes receiving the local identifier and the most-recent hash value from a local computer system storing the local ledger.

(A8) In any of the methods denoted (A1) to (A7), the method further includes storing the local ledger. Said updating includes appending the new block to the local ledger.

(A9) In any of the methods denoted (A1) to (A8), the method further includes traversing the tapestry in reverse order to search for a path that (i) starts with a first event stored in a first block of a first ledger of the plurality of time-ordered cryptographic ledgers and (ii) ends with a second event stored in a second block of a second ledger of the plurality of time-ordered cryptographic ledgers. The method further includes outputting, in response to the path being found, an indication that the second event preceded the first event.

(A10) In the method denoted (A9), the method further includes traversing, in response to the path not being found, the tapestry in reverse order to search for an alternative path that (i) starts with the second event and (ii) ends with the first event. The method further includes outputting, in response to the alternative path being found, an indication that the first event preceded the second event.

(A11) In the method denoted (A10), the method further includes outputting, in response to the alternative path not being found, an indication that the first and second events occurred simultaneously.

(A12) In any of the methods denoted (A9) to (A11), the local ledger is one of the first ledger and the second ledger.

(B1) A local computer node includes a processor and a memory in communication with the processor. The memory stores machine-readable instructions that, when executed by the processor, control the local computer node to receive mix-in data from a remote computer node of one or more remote computer nodes storing one or more remote ledgers, respectively, of a plurality of time-ordered cryptographic ledgers forming a tapestry. The mix-in data includes a remote identifier that uniquely identifies a remote ledger, of the one or more remote ledgers, among the plurality of time-ordered cryptographic ledgers. The remote ledger is stored on the remote computer node. The mix-in data also includes a remote hash value stored in a block of the remote ledger. The machine-readable instructions, when executed by the processor, also control the local computer node to generate a new hash value by hashing (i) local event data, (ii) the mix-in data, (iii) a local identifier that uniquely identifies a local ledger among the plurality of time-ordered cryptographic ledgers, and (iv) a most-recent hash value of a most-recent block of the local ledger. The machine-readable instructions, when executed by the processor, also control the local computer node to construct a new block that stores (i) the local event data, (ii) the mix-in data, (iii) the local identifier, (iv) the most-recent hash value, and (v) the new hash value. The machine-readable instructions, when executed by the processor, also control the local computer node to update the local ledger with the new block.

(B2) In the local computer node denoted (B1), the memory stores additional machine-readable instructions that, when executed by the processor, control the local computer node to transmit, to at least one of the one or more remote computer nodes, (i) the new hash value and (ii) the local identifier.

(B3) In either of the local computer nodes denoted (B1) and (B2), the local computer node includes a local event generator configured to generate the local event data.

(B4) In the local computer node denoted (B3), the local event generator includes a random number generator configured to generate one or more random numbers. The local event data includes the one or more random numbers.

(B5) In any of the local computer nodes denoted (B1) to (B4), the local computer node includes a clock configured to generate a time-stamp. The local event data includes the time stamp.

(B6) In any of the local computer nodes denoted (B1) to (B5), the memory stores additional machine-readable instructions that, when executed by the processor, control the local computer node to transmit the new block to a local computer system storing the local ledger.

(B7) In any of the local computer nodes denoted (B1) to (B6), the memory stores additional machine-readable instructions that, when executed by the processor, control the local computer node to receive the local identifier and the most-recent hash value from a local computer system storing the local ledger.

(B8) In the local computer node denoted (B7), the local computer node is one of a tablet, a smartphone, and a laptop computer.

(B9) In any of the local computer nodes denoted (B1) to (B8), the memory stores the local ledger. The machine-readable instructions that, when executed by the processor, control the local computer node to update the local ledger include machine-readable instructions that, when executed by the processor, control the local computer node to append the new block to the local ledger.

(B10) In any of the local computer nodes denoted (B1) to (B9), the memory stores additional machine-readable instructions that, when executed by the processor, control the local computer node to traverse the tapestry in reverse order to identify a path that (i) starts with a first event stored in a first block of a first ledger of the plurality of time-ordered cryptographic ledgers and (ii) ends with a second event stored in a second block of a second ledger of the plurality of time-ordered cryptographic ledgers. The additional machine-readable instructions, when executed by the processor, also control the local computer node to output, in response to the path being identified, an indication that the second event preceded the first event.

(B11) In the local computer node denoted (B10), the memory stores additional machine-readable instructions that, when executed by the processor, control the local computer node to traverse, in response to the path not being identified, the tapestry in reverse order to identify an alternative path that (i) starts with the second event and (ii) ends with the first event. The additional machine-readable instructions, when executed by the processor, also control the local computer node to output, in response to the alternative path being identified, an indication that the first event preceded the second event.

(B12) In the local computer node denoted (B11), the memory stores additional machine-readable instructions that, when executed by the processor, control the local computer node to output, in response to the alternative path not being identified, an indication that the first and second events occurred simultaneously.

(B13) In any of the local computer nodes denoted (B9) to (B11), the local ledger is one of the first ledger and the second ledger.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method performed by a local computer node, comprising:
receiving mix-in data from a remote computer node of one or more remote computer nodes storing one or more remote ledgers, respectively, of a plurality of time-ordered cryptographic ledgers forming a tapestry, the mix-in data comprising:
a remote identifier that uniquely identifies a remote ledger, of the one or more remote ledgers, among the plurality of time-ordered cryptographic ledgers, the remote ledger being stored on the remote computer node; and
a remote hash value stored in a block of the remote ledger;
generating a new hash value by hashing (i) local event data, (ii) the mix-in data, (iii) a local identifier that uniquely identifies a local ledger among the plurality of time-ordered cryptographic ledgers, and (iv) a most-recent hash value of a most-recent block of the local ledger;
constructing a new block that stores (i) the local event data, (ii) the mix-in data, (iii) the local identifier, (iv) the most-recent hash value, and (v) the new hash value; and
updating the local ledger with the new block.

2. The method of claim 1, further comprising transmitting, to at least one of the one or more remote computer nodes, (i) the new hash value and (ii) the local identifier.

3. The method of claim 1, further comprising receiving the local event data.

4. The method of claim 1, further comprising generating a time stamp, the local event data including the time stamp.

5. The method of claim 1, further comprising generating one or more random numbers, the local event data including the one or more random numbers.

6. The method of claim 1, wherein said updating comprises transmitting the new block to a local computer system storing the local ledger.

7. The method of claim 1, further comprising receiving the local identifier and the most-recent hash value from a local computer system storing the local ledger.

8. The method of claim 1, wherein:
the method further comprises storing the local ledger; and
said updating comprises appending the new block to the local ledger.

9. The method of claim 1, further comprising:
traversing the tapestry in reverse order to search for a path that (i) starts with a first event stored in a first block of a first ledger of the plurality of time-ordered cryptographic ledgers and (ii) ends with a second event stored in a second block of a second ledger of the plurality of time-ordered cryptographic ledgers; and
outputting, in response to the path being found, an indication that the second event preceded the first event.

10. The method of claim 9, further comprising:
traversing, in response to the path not being found, the tapestry in reverse order to search for an alternative path that (i) starts with the second event and (ii) ends with the first event; and
outputting, in response to the alternative path being found, an indication that the first event preceded the second event.

11. The method of claim 10, further comprising outputting, in response to the alternative path not being found, an indication that the first and second events occurred simultaneously.

12. The method of claim 9, wherein the local ledger is one of the first ledger and the second ledger.

13. A local computer node, comprising:
a processor; and
a memory in communication with the processor, the memory storing machine-readable instructions that, when executed by the processor, control the local computer node to:
receive mix-in data from a remote computer node of one or more remote computer nodes storing one or more remote ledgers, respectively, of a plurality of time-ordered cryptographic ledgers forming a tapestry, the mix-in data comprising:
a remote identifier that uniquely identifies a remote ledger, of the one or more remote ledgers, among the plurality of time-ordered cryptographic ledgers, the remote ledger being stored on the remote computer node, and
a remote hash value stored in a block of the remote ledger,
generate a new hash value by hashing (i) local event data, (ii) the mix-in data, (iii) a local identifier that uniquely identifies a local ledger among the plurality of time-ordered cryptographic ledgers, and (iv) a most-recent hash value of a most-recent block of the local ledger,
construct a new block that stores (i) the local event data, (ii) the mix-in data, (iii) the local identifier, (iv) the most-recent hash value, and (v) the new hash value, and
update the local ledger with the new block.

14. The local computer node of claim 13, the memory storing additional machine-readable instructions that, when executed by the processor, control the local computer node to transmit, to at least one of the one or more remote computer nodes, (i) the new hash value and (ii) the local identifier.

15. The local computer node of claim 13, further comprising a local event generator configured to generate the local event data.

16. The local computer node of claim 15, the local event generator comprising a random number generator configured to generate one or more random numbers, the local event data including the one or more random numbers.

17. The local computer node of claim 13, further comprising a clock configured to generate a time stamp, the local event data including the time stamp.

18. The local computer node of claim 13, the memory storing additional machine-readable instructions that, when executed by the processor, control the local computer node to transmit the new block to a local computer system storing the local ledger.

19. The local computer node of claim 13, the memory storing additional machine-readable instructions that, when executed by the processor, control the local computer node to receive the local identifier and the most-recent hash value from a local computer system storing the local ledger.

20. The local computer node of claim 19, being one of a tablet, a smartphone, and a laptop computer.

21. The local computer node of claim 13, wherein:
the memory stores the local ledger; and
the machine-readable instructions that, when executed by the processor, control the local computer node to update the local ledger include machine-readable instructions that, when executed by the processor, control the local computer node to append the new block to the local ledger.

22. The local computer node of claim 13, the memory storing additional machine-readable instructions that, when executed by the processor, control the local computer node to:
traverse the tapestry in reverse order to search for a path that (i) starts with a first event stored in a first block of a first ledger of the plurality of time-ordered cryptographic ledgers and (ii) ends with a second event stored in a second block of a second ledger of the plurality of time-ordered cryptographic ledgers, and
output, in response to the path being found, an indication that the second event preceded the first event.

23. The local computer node of claim 22, the memory storing additional machine-readable instructions that, when executed by the processor, control the local computer node to:
traverse, in response to the path not being found, the tapestry in reverse order to search for an alternative path that (i) starts with the second event and (ii) ends with the first event, and
output, in response to the alternative path being found, an indication that the first event preceded the second event.

24. The local computer node of claim 23, the memory storing additional machine-readable instructions that, when executed by the processor, control the local computer node to output, in response to the alternative path not being found, an indication that the first and second events occurred simultaneously.

25. The local computer node of claim 22, the local ledger being one of the first ledger and the second ledger.
